(19) United States
(12) Patent Application Publication
(10) Pub. No.: US 2011/0311269 A1
(43) Pub. Date: Dec. 22, 2011

(54) IMAGE FORMING APPARATUS

(75) Inventor: Ken Murooka, Mishima-shi (JP)

(73) Assignee: CANON KABUSHIKI KAISHA, Tokyo (JP)

(21) Appl. No.: 13/163,906

(22) Filed: Jun. 20, 2011

(30) Foreign Application Priority Data
Jun. 22, 2010 (JP) 2010-141623
May 16, 2011 (JP) 2011-109192

(51) Int. Cl. G03G 15/00; G03G 21/18; G03G 15/04

(52) U.S. Cl. 399/110; 399/111; 399/119

(57) ABSTRACT

An image forming apparatus for forming an image on a recording material includes a cartridge mounting portion to which a cartridge is detachably mountable; a stacking portion for accommodating the recording material; and a protecting cover for protecting the recording material accommodated in the stacking portion, wherein the protecting cover is movable between a first position in which the recording material accommodated in the stacking portion is protected and a second position in which movement of the cartridge mounted in the cartridge mounting portion is prevented.

### FIELD OF THE INVENTION AND RELATED ART

The present invention relates to an image forming apparatus capable of being transported in a state in which a cartridge is mounted in an apparatus main assembly. Particularly, the present invention is suitably applied to the image forming apparatus, such as a copying machine or a printer (e.g., a laser printer or an LED printer), for forming an image on a recording material (e.g., paper or an OHP sheet) by using an image bearing member for forming a latent image.

Here, the image bearing member is not limited to a member represented by a photosensitive drum such that the latent image is formed by causing light to act on the photosensitive drum but also includes members for forming the latent image by causing magnetism or electricity to act thereon.

Further, a process cartridge as the cartridge is as follows. That is, in an electrophotographic type, an electrophotographic photosensitive drum and at least one of process means including a charging means, a developing means and a cleaning means are integrally assembled into a cartridge which is detachably mountable to the apparatus main assembly. Therefore, the process cartridge includes a cartridge which is prepared by integrally assembling the electrophotographic photosensitive drum and the developing means as the process means and is detachably mountable to the apparatus main assembly of the electrophotographic image forming apparatus. Further, the process cartridge also includes a cartridge which is prepared by integrally assembling the electrophotographic photosensitive drum and the charging means and the developing means or the cleaning means as the process means and is detachably mountable to the apparatus main assembly. Incidentally, the process cartridge integrally including the electrophotographic photosensitive drum and the developing means is of a so-called integral type. Further, the process cartridge integrally including the electrophotographic photosensitive drum and the process means other than the developing means is of a so-called separation type. That is, the type of the process cartridge in which the electrophotographic photosensitive drum and the process means other than the developing means are integrally assembled is referred to as the separation type.

Here, the process cartridge can be mounted to and demounted from the apparatus main assembly by a user himself (herself). For that reason, maintenance of the apparatus main assembly can be easily performed. Incidentally, the process means described above acts on the electrophotographic photosensitive drum.

Further, the developing cartridge includes a developing roller and accommodates a developer (toner) used for developing, by the developing roller, an electrostatic latent image formed on the electrophotographic photosensitive drum. The developing cartridge is detachably mountable to the apparatus main assembly. Incidentally, in the case of the developing cartridge, the electrophotographic photosensitive drum is mounted in the apparatus main assembly or a cartridge supporting member. Alternatively, the electrophotographic photosensitive drum is provided in the process cartridge of the separation type. In this case, the process cartridge does not include the developing means. The developing cartridge can be mounted to and demounted from the apparatus main assembly by the user himself (herself). For that reason, the maintenance of the apparatus main assembly can be easily performed. The cartridge includes those of the integral type and the separation type. The cartridge also includes the case where the separation type process cartridge and the developing cartridge are used as a pair. Further, the cartridge also includes the case where the electrophotographic photosensitive drum is fixedly mounted to the apparatus main assembly or the cartridge supporting member and the developing cartridge is used so as to be actable on and detachably mountable to the electrophotographic photosensitive drum.

A conventional image forming apparatus has been generally subjected to factory shipment in a state in which the process cartridge is not mounted in the apparatus main assembly of the electrophotographic image forming apparatus and is packed separately from the apparatus main assembly in a package. However, in recent years, it has been tried to improve distribution efficiency by downsizing the package as small as possible. For that reason, in recent years, there is a product shipped in a state in which the process cartridge is mounted in the image forming apparatus main assembly and is fixed and held by providing a pressing member such as expanded polystyrene inside the apparatus main assembly. An example thereof is disclosed in Japanese Laid-Open Patent Application 2006-171407.

Thus, the conventional image forming apparatus has been required to provide a packing member such as expanded polystyrene inside the apparatus main assembly for preventing movement of the cartridge in order to transport the image forming apparatus in a cartridge-mounted state.

### SUMMARY OF THE INVENTION

A principal object of the present invention is to provide an image forming apparatus capable of reducing product cost by reducing the number of parts for packing member provided for preventing movement of a cartridge.

According to an aspect of the present invention, there is provided an image forming apparatus for forming an image on a recording material, comprising:

a cartridge mounting portion to which a cartridge is detachably mountable;

a stacking portion for accommodating the recording material; and

a protecting cover for protecting the recording material accommodated in the stacking portion, wherein the protecting cover is movable between a first position in which the recording material accommodated in the stacking portion is protected and a second position in which movement of the cartridge mounted in the cartridge mounting portion is prevented.

The image forming apparatus is transportable in a state in which the cartridge is detachably mounted in the cartridge mounting portion of an apparatus main assembly. When the image forming apparatus is transported, the protecting cover is located at the second position.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

Part (A) of FIG. 1 is an illustration of a protecting cover during image formation and during transportation in First Embodiment of the present invention, and (B) of FIG. 1 is a perspective view of the protecting cover provided with a cartridge movement-preventing portion in First Embodiment.

Part (A) of FIG. 2 is a sectional view of an image forming apparatus in First Embodiment, and (B) of FIG. 2 is an illustration of a sheet feeding system.

FIG. 3 is a perspective view of a process cartridge in the present invention.

Part (A) of FIG. 4 is an illustration relating to movement of the process cartridge, and (B) of FIG. 4 is a detailed sectional view for illustrating the movement of the process cartridge.

Part (A) of FIG. 5 is a detailed sectional view showing a state of the protecting cover during image formation in First Embodiment, and (B) of FIG. 5 is a detailed sectional view showing a state of the protecting cover during transportation in First Embodiment.

Part (A) of FIG. 6 is a plan view of the protecting cover and the process cartridge in First Embodiment, and (B) of FIG. 6 is a partly enlarged view of a portion A, indicated in (A) of FIG. 6, including the protecting cover and the process cartridge at a rear and side end portion.

FIG. 7 is a perspective view for illustrating an image forming apparatus in Second Embodiment in which movement prevention of a protecting cover itself is effected by a preventing portion.

FIG. 8 is a perspective view showing a shipment state of the image forming apparatus in First and Second Embodiments.

Part (A) of FIG. 9 is a detailed sectional view showing an image forming apparatus during image formation in Third Embodiment, and (B) of FIG. 9 is a detailed sectional view showing the image forming apparatus during transportation in Third Embodiment.

### DESCRIPTION OF THE PREFERRED EMBODIMENTS

Hereinbelow, embodiments of the present invention will be described with reference to the drawings. Incidentally, in the following description, the same or corresponding portions or members are represented by the same reference numerals or symbols.

### First Embodiment

### (Image Forming Apparatus)

An image forming apparatus, of this embodiment according to the present invention, which is transportable in a state in which a process cartridge is detachably mounted will be described by taking a laser printer as an example. Part (A) of FIG. 2 is a sectional side view of the laser printer. In an apparatus main assembly 1 of the laser printer, a process cartridge 10 is detachably mounted.

In the process cartridge 10, a photosensitive drum 11 as an image bearing member and process devices, provided around the photosensitive drum 11, such as a primary charger 12, a developing device 13 and a cleaning device are incorporated. A scanner unit 15 emits laser light 5 and scans the drum 11. The drum 11 is uniformly charged by the primary charger 12 and then is irradiated with the laser light 5 emitted from the scanner unit 15. As a result, an electrostatic latent image corresponding to desired image information is formed on the drum 11 and then is developed by the developing device 13 as a developing means.

A sheet stacking portion 42 is fixed in the apparatus main assembly 1. A pair of sheet width regulating plates 43 is disposed linearly movable in the apparatus main assembly 1 and determines a position of a transfer paper P as a sheet of a recording material with respect to a left-right direction by regulating the sheet width of the transfer paper P with respect to a widthwise direction. A sheet feeding tray 46 is used as a stacking tray for stacking the transfer paper P to be fed to the apparatus main assembly 1. The sheet feeding tray 46 is provided rotatably about a rotational movement fulcrum Q relative to the apparatus main assembly 1 and is movable between a position in which it covers the sheet stacking portion 42 and a position in which it opens the sheet stacking portion 42.

When the transfer paper P is fed to the apparatus main assembly 1, the sheet feeding tray 46 is opened to open the sheet stacking portion 42, so that the transfer paper P is placed on the sheet stacking portion 42. Here, when the sheet feeding tray 46 is opened the bottom surface of the sheet stacking portion 42 and the upper surface of the sheet feeding tray 46 are on the substantially same plane. A part of the transfer paper P is protruded from the inside of the apparatus main assembly 1 to the outside of the apparatus main assembly 1 but the protruded portion is placed on the opened sheet feeding tray 46. Here, as shown in (B) of FIG. 2, in order to protect the protruded portion of the transfer paper P outside the apparatus main assembly 1, a protecting cover 30 is provided. The protecting cover 30 is placed on the sheet feeding tray 46 to cover the portion of the transfer paper P protruded from the apparatus main assembly 1 thus suppressing deposition of dust or the like on the transfer paper P. Then, the transfer paper P is upward urged by a spring 61 to be stacked on the sheet stacking portion 42 along an inclined intermediate plate 60. Inside the sheet stacking portion 42, a leading end of the transfer paper P contacts a sheet feeding roller 17 for feeding sheets of the transfer paper P into the apparatus main assembly 1 one by one. The transfer paper P fed by the sheet feeding roller supported by a spring 20 is conveyed toward the drum 11 by conveying rollers 18a and 18b in synchronism with the rotation of the drum 11. A transfer charger 19 transfers a developer image, onto the transfer paper P, formed on the drum 11 by the developing device 13. A fixing device 21 heat-fixes the image on the transfer paper P. Sheet discharging rollers 22a and 22b discharge, after the fixing, the transfer paper P onto a discharge stacking portion.

In the above constitution, when a print start instruction is inputted from an unshown computer or image reader or the like, the laser printer starts a printing (image forming) operation. Then, an uppermost sheet of the sheets of the transfer paper P stacked on the sheet feeding tray 46 is fed into the apparatus main assembly 1 by the sheet feeding roller 17. Then, the transfer paper P is conveyed upward from a lower portion of the apparatus main assembly 1 by the conveying rollers 18a and 18b in the apparatus main assembly 1 shown in FIG. 1 and then passes through a portion between the drum 11 and the transfer charger and through the fixing device 21. When the printing (image formation) is effected on the transfer paper P in accordance with a known electrophotographic process, the transfer paper P is discharged to the outside of the image forming apparatus.

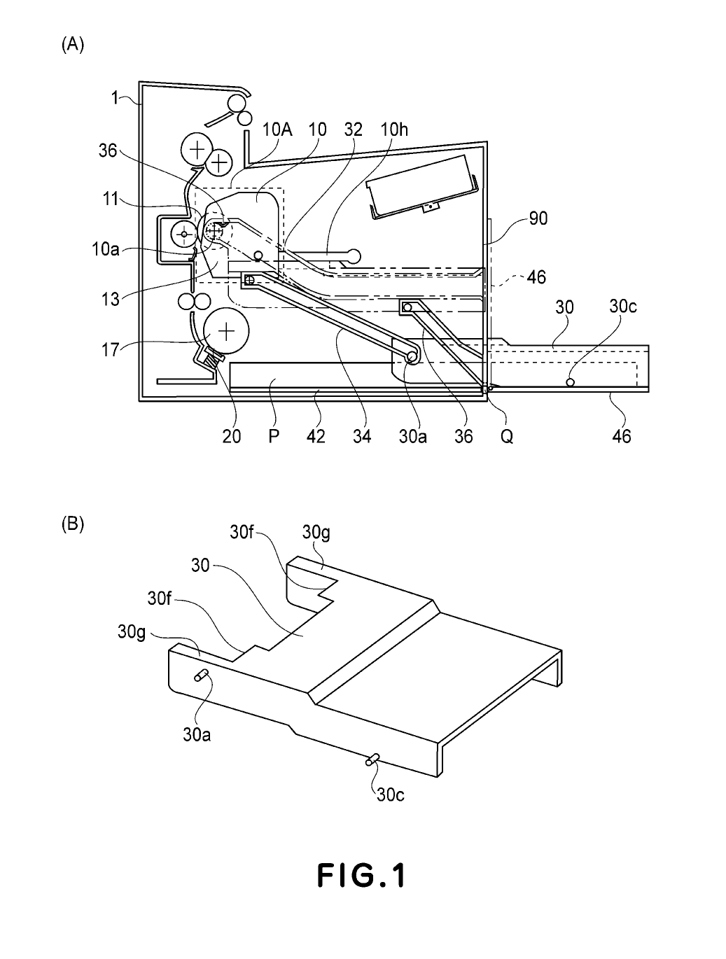

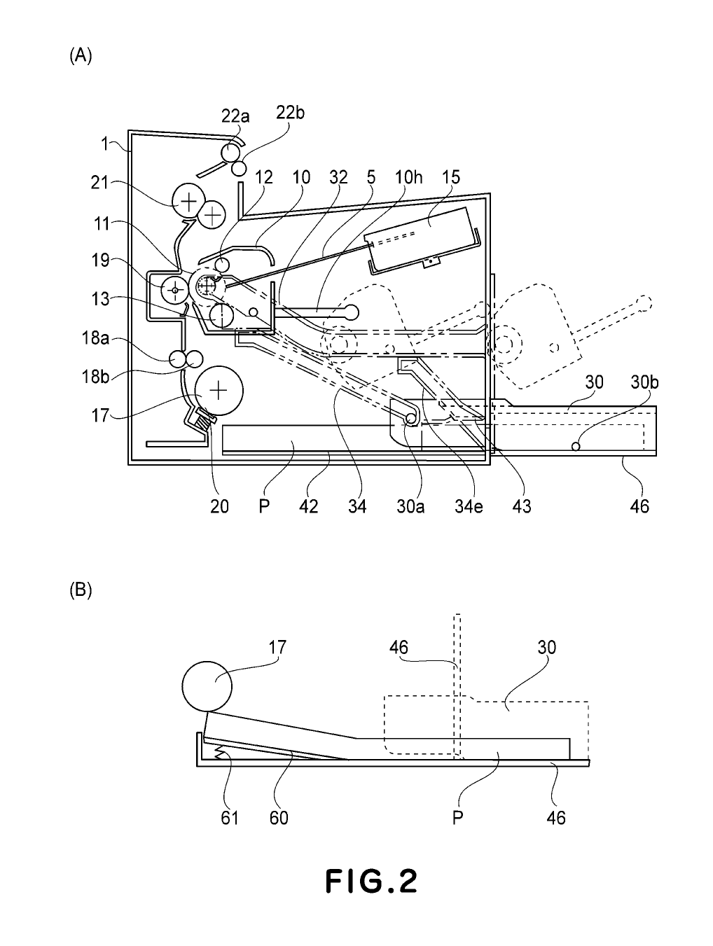

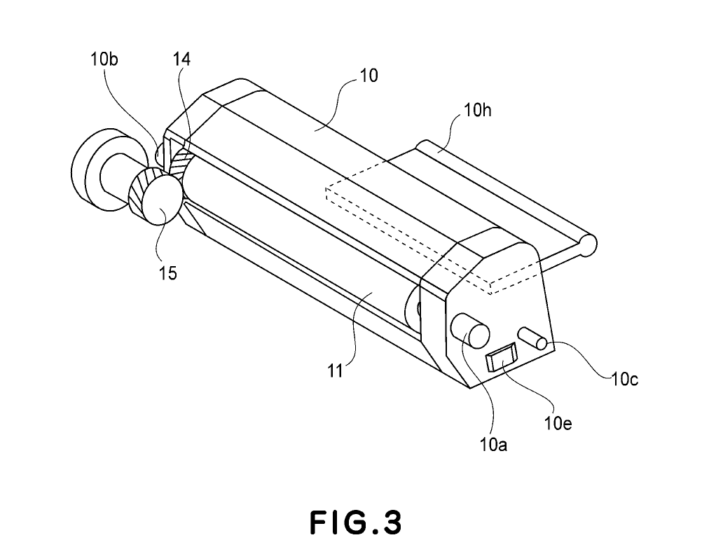

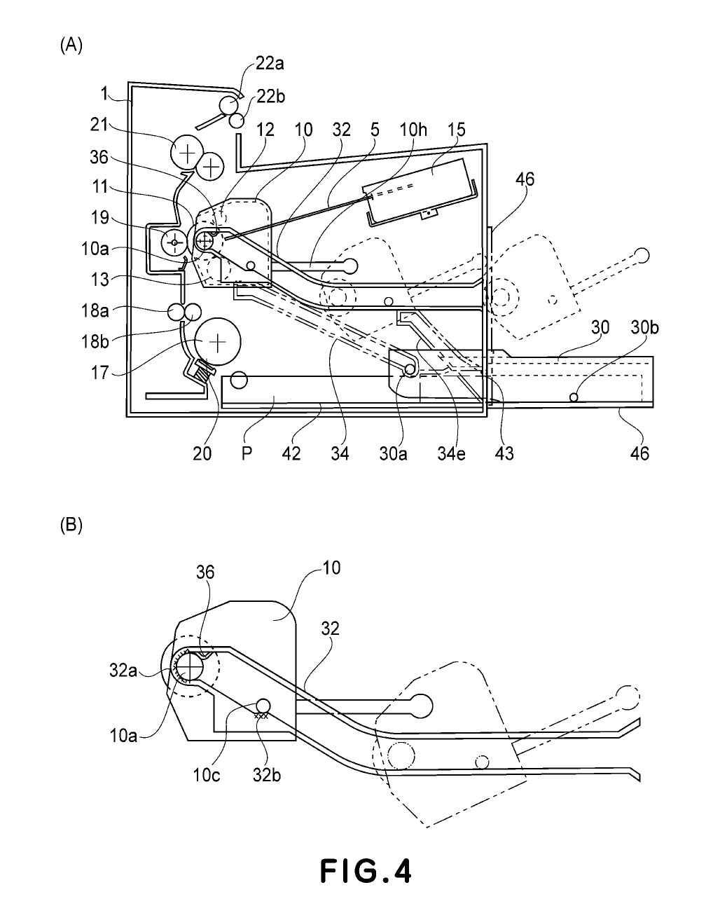

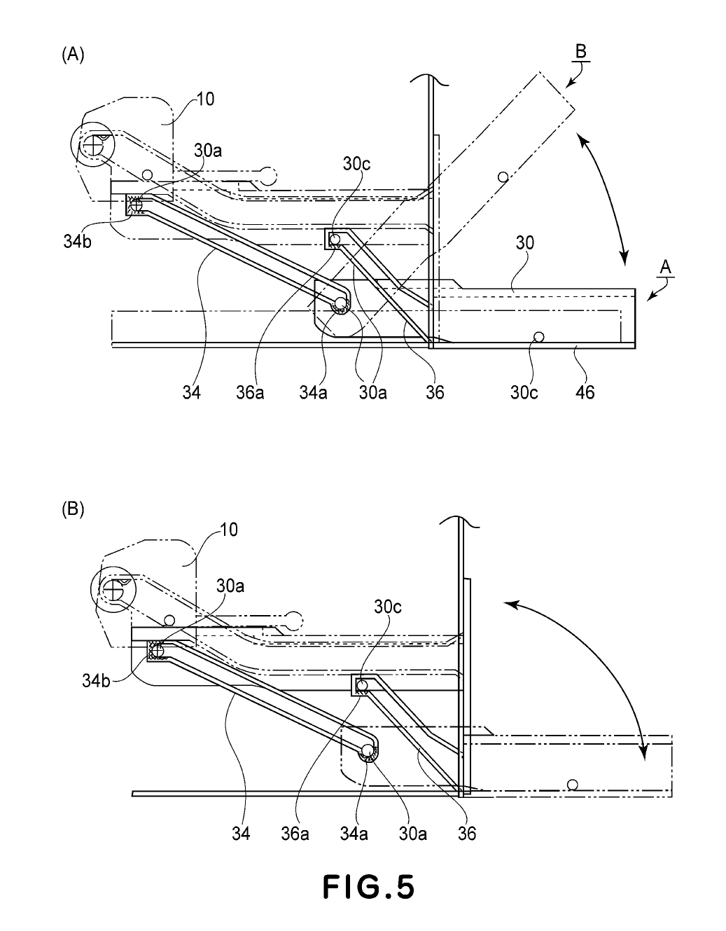

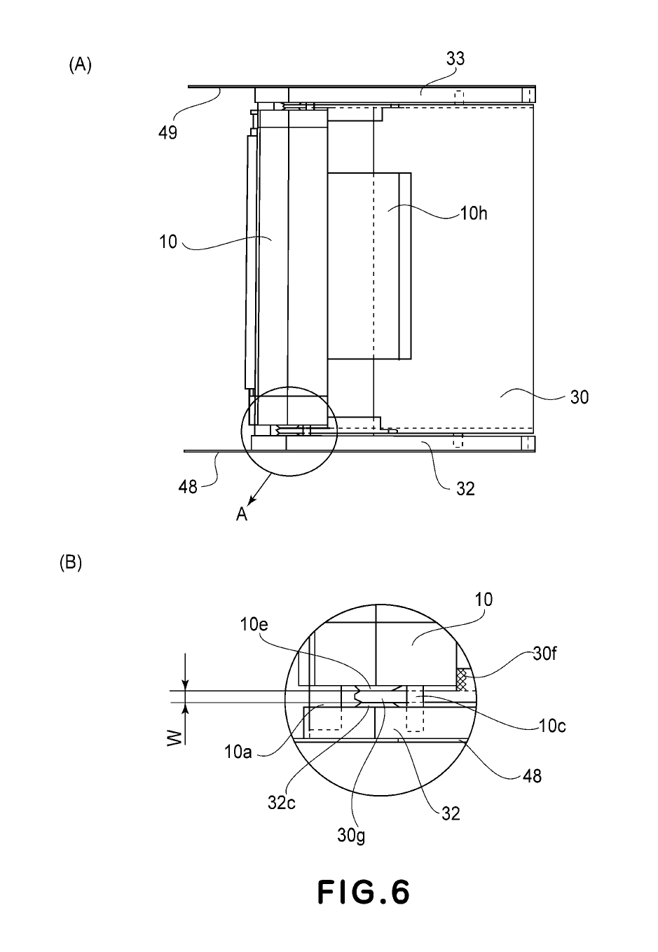

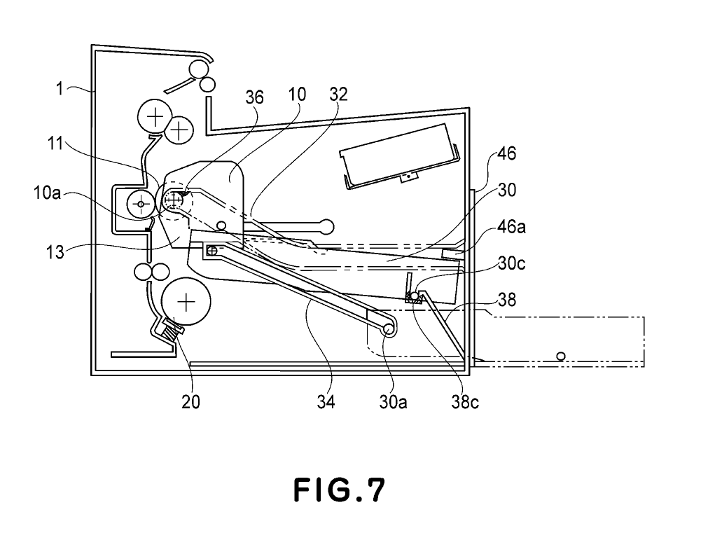

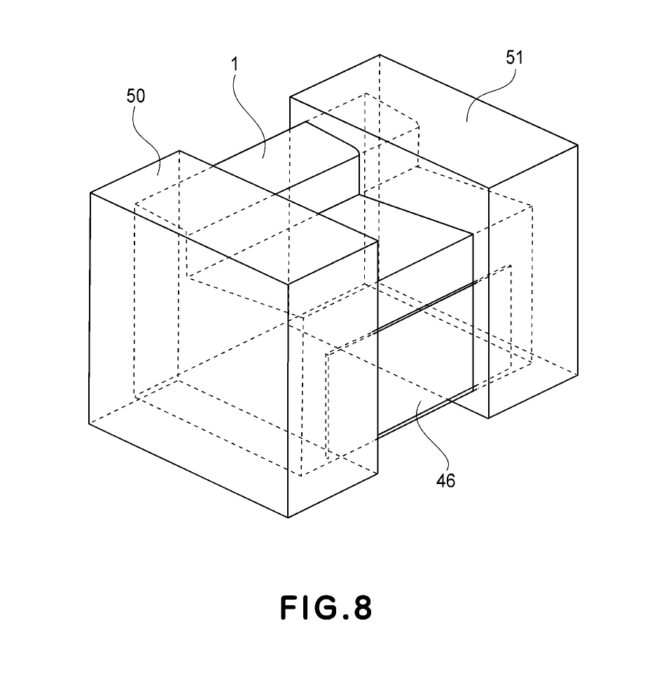

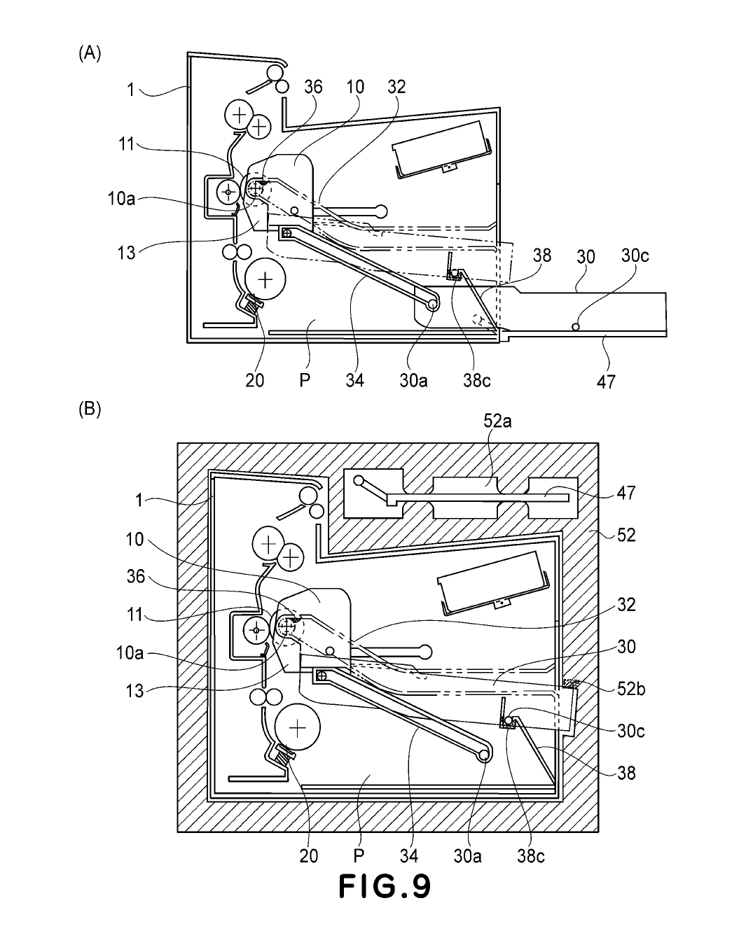

A detailed portion of the laser printer of the present invention will be described. FIG. 3 is a perspective view for illustrating respective portions of the process cartridge. On left and right side surfaces of the process cartridge 10, first positioning portions 10a and 10b which constitute a front end side during insertion thereof into the apparatus main assembly of the image forming apparatus with the use of a handle 10h, and second positioning portions 10c and 10d which constitute a rear end side during the insertion are provided. The first positioning portions 10a and 10b are coaxially aligned with the drum 11 ((A) of FIG. 2) and are used for accurately determining the position of the drum 11 relative to the apparatus main assembly 1. Further, the second positioning portions 10c and 10d are used for determining the position of the drum 11 with respect to a rotational direction of process cartridge 10 with the drum 11 as an axis. The second positioning portions 10c and 10d are located at bilaterally symmetric positions of the process cartridge 10. On the side surfaces of the process cartridge 10, widthwise abutting portions 10e and 10f of the process cartridge 10 are provided. In this embodiment, an example in which the first positioning portions 10a and 10b, the second positioning portions 10c and 10d and the widthwise abutting portions 10a and 10f are located at bilaterally symmetric portions of the process cartridge 10, respectively, and the portions 10d and 10f are omitted from illustration in FIG. 3.

At one side end portion of the drum 11 of the process cartridge 10 in FIG. 3, a drum gear 14 is integrally disposed with the drum 11. A driving force is transmitted from an unshown driving source at the apparatus main assembly side to the drum gear 15 via a drum driving gear.

Next, a guide rail for mounting the process cartridge 10 into the apparatus main assembly 1 will be described with reference to (A) and (B) of FIG. 4. Part (A) of FIG. 4 is an illustration relating to movement of the process cartridge, and (B) of FIG. 4 is a detailed sectional view for illustrating the movement of the process cartridge.

The apparatus main assembly 1 is provided with an opening 90 ((A) of FIG. 1) for permitting mounting of the process cartridge 10 into the apparatus main assembly 1. Further, on an inner wall of the apparatus main assembly 1, a pair of cartridge guide rails 32 and 33 for guiding the process cartridge 10 to a process cartridge mounting portion 10A ((A) of FIG. 1) in the apparatus main assembly 1 via the opening 90are provided at left and right sides in a bilaterally symmetrical manner. Therefore, only the cartridge guide rail 32 will be described and the cartridge guide rail 33 is omitted from the description. In a groove of the guide rail 32, an abutting portion 32a ((B) of FIG. 4) as a positioning portion of the process cartridge 10 and a rotation stopping portion 32b ((B) of FIG. 4) for determining the position of the process cartridge 10 with respect to the rotational direction are provided. Further, in the neighborhood of the abutting portion 32a of the cartridge guide rail 32, a cartridge pressing spring 36 for pressing the positioning portion 10a of the process cartridge 10 against the abutting portion 32a is provided.

Here, the openable sheet feeding tray 46 is configured to also cover the opening 90 ((A) of FIG. 1) when it covers the sheet stacking portion 42. That is, the sheet feeding tray 46 is the openable member which is movable between a closed position in which it covers the opening 90 and an open drum in which it opens (exposes) the opening 90. As a result, when the laser printer is not used, the sheet feeding tray 46 is located at the closed position, so that both of the cartridge mounting portion 10A and the sheet stacking portion 42 can be protected. Another openable member for opening and closing the opening 90 may also be provided separately from the sheet feeding tray 46.

In a state in which the sheet feeding tray 46 is opened, a status in which the handle 10h of the process cartridge 10 is held and the process cartridge 10 is inserted from a front side of the apparatus main assembly 1 is shown in (A) of FIG. 4. The first positioning portion 10a of the process cartridge 10 is guided along the groove of the cartridge guide rail 32 and is fixed at the cartridge abutting portion 32a, at a position in which the drum 11 contacts the transfer roller 19, by the cartridge pressing spring 36.

On the other hand, the second positioning portion 10c is also guided along the groove of the cartridge guide rail 32 and is fixed at a position in which it abuts against the rotation stopping portion 32b ((B) of FIG. 4) of the cartridge guide rail 32.

Part (A) of FIG. 1 is an illustration of the protecting cover during image formation and during transportation in this embodiment. Part (A) of FIG. 5 is a detailed sectional view of the protecting cover during the image formation in this embodiment, and (B) of FIG. 5 is a detailed sectional view showing a state of the protecting cover during transportation. As shown in (A) and (B) of FIG. 5, at left and right sides of the protecting cover 30, rotational movement shafts 30a and 30b having a projection shape such as a cylindrical shape and guide shafts 30c and 30d are provided. The rotational movement shafts 30a and 30b and the guide shafts 30c and 30d are bilaterally symmetrical and therefore only the shafts 30a and 30c will be described and the shafts 30b and 30d are omitted from the description. The rotational movement shaft 30a is rotatably locked at a rotation center 34a of a protecting cover guide rail 34. When the transfer paper P is mounted, the protecting cover 30 is rotationally moved by the rotational movement shaft 30a to a state (position B in (A) of FIG. 5) in which the protecting cover 30 is opened so as to facilitate the mounting of the transfer paper P. The protecting cover 30 functions as a dust-proofing cover for the transfer paper P in a closed state (position A in (A) of FIG. 5) during printing (image formation). Incidentally, when the protecting cover 30 is located at the position A shown in (A) of FIG. 5, the protecting cover 30 is placed on the sheet feeding tray 46, thus being stably supported by the sheet feeding tray 46.

Further, a pair of left and right protecting cover guide rails 34 and 35 and a pair of left and right protecting cover guide rails 36 and 37 are used for guiding the protecting cover 30 into the apparatus main assembly 1. The protecting cover guide rails 34 and 35, and 36 and 37 are bilaterally symmetrical and therefore only the protecting cover guide rails 34 and 36 will be described and the protecting cover guide rails 35 and 37 are omitted from the description. The protecting cover guide rail 34 is fixed at the apparatus main assembly 1 side and is provided with a rotation center 34a of the rotational movement shaft 30a of the protecting cover 30 during the printing of the image forming apparatus and provided with an abutting portion 34b as a positioning portion when the protecting cover 30 is accommodated in the apparatus main assembly 1. Further, the guide rail 36 guides a guide shaft 30c provided at a rear portion of the protecting cover 30. The guide rail 36 guides the guide shaft 30c during the protecting cover accommodation and is provided with a fixing portion 36a for the guide shaft 30c.

Next, the configuration of the apparatus main assembly during transportation (during shipment) will be described. During the printing (image formation), the process cartridge 1 is mounted, at the process cartridge mounting portion 10A ((A) of FIG. 1) and the protecting cover 30 is fixed at the position indicated by a solid line in (A) of FIG. 5. In this state, the protecting cover 30 is moved from the drum during the printing (A) of FIG. 5) to a position, indicated by the solid line, in which the protecting cover 30 is accommodated in the apparatus main assembly ((B) of FIG. 5). During the printing (image formation), the rotational movement shaft 30a is located at the position of the rotation center 34a of the guide rail 34 but is moved, in a state of transportation (or shipment), to the position of the abutting portion 34 of the guide rail 34, so that the protecting cover 30 is in the state of being accommodated in the apparatus main assembly. Similarly, the guide shaft 30c is located on the sheet feeding tray 46 during the image formation but is moved, in the state of transportation (or shipment), to a position in which it abuts against the abutting portion 36a of the guide rail 36.

In this embodiment, the protecting cover 30 is provided, as shown in (B) of FIG. 1, with rear end urging portion 30f for preventing movement of the cartridge as a first preventing portion contactable to the rear end portions of the process cartridge at its end portion sides with respect to its movement direction. Further, the protecting cover 30 is provided with front end portions 30g for preventing movement of the cartridge as a second preventing portion contactable to side end portions of the process cartridge at its end portion sides with respect to its movement direction.

With respect to the cartridge movement prevention, (A) of FIG. 6 is a top view of the process cartridge 10 and the protecting cover 30 in a state in which the protecting cover 30 is accommodated in the apparatus main assembly. Further, (B) of FIG. 6 is an enlarged view of a portion A, shown in (A) of FIG. 6, in the neighborhood of the first positioning portion 10a (at only one side). Side plates 48 and 49 of the image forming apparatus are formed with a metal plate or the like. On the side plates, the cartridge guide rails 32 and 33 are fixed, and the cartridge guide rails 32 and 33 are provided with projections 32a ((B) of FIGS. 6) and 33c. On the other hand, the process cartridge 10 is provided with widthwise abutting portions 10e ((B) of FIGS. 6) and 10f.

Here, between the widthwise abutting portion 10e (10f) and the projection 32c (33c) of the cartridge 32, there is a gap W ((B) of FIG. 6) for permitting smooth insertion and extraction of the process cartridge 10 with respect to the apparatus main assembly 1. In this embodiment, the front end portion 30a of the protecting cover 30 enters the gap W and functions as a preventing portion for preventing movement of the process cartridge 10 in a direction crossing a demounting direction of the process cartridge 10, so that jerky of the process cartridge 10 with respect to this direction can be minimized.

Further, in this embodiment, as shown in (B) of FIG. 6, the protecting cover 30 is provided with the cartridge urging portion 30f. This cartridge urging portion 30f functions as a preventing portion for preventing movement of the process cartridge 10 in the cartridge demounting direction, thus urging the process cartridge so as not to be demounted from the apparatus main assembly 1 in the demounting direction.

That is, the front end portion 30g of the protecting cover 30 prevents movement of the side end portion of the process cartridge 10, and the urging portion 30f prevents movement of the rear end portion of the process cartridge 10.

In this embodiment, the protecting cover 30 is not always required to be provided with these portions 30g and 30f but may also be provided with only either one of these portions 30g and 30f.

In this embodiment, in the case where impact on the like occurs, the movement of the protecting cover 30 itself is substantially prevented by the sheet feeding tray 46 which is the openable member movable between the closed position in which the tray 46 covers the opening 90 and the open position in which the tray 46 opens the opening 90. That is, a force exerted in a direction in which the protecting cover 30 is pushed out to the outside of the apparatus main assembly 1 by the process cartridge 10 is received by the sheet feeding tray 46. As a result, even in the case where the impact or the like occurs during transportation, it is possible to prevent the process cartridge 10 from moving to the outside of the apparatus main assembly 1.

Further, it is also possible to accommodate the protecting cover 30 inside the apparatus main assembly 1 not only during transportation of the laser printer but also when the laser printer is not used. For that reason, when the laser printer is not used, the protecting cover 30 is accommodated inside the apparatus main assembly 1 and then the sheet feeding tray 46 can be closed. Thus, the laser printer can be placed in a downsized state.

That is, according to this embodiment, it is possible to suppress an occurrence of a dedicated packing member when the image forming apparatus is transported in a state in which the process cartridge 10 is mounted in the apparatus main assembly 1, so that it becomes possible to transport the image forming apparatus inexpensively.

### Second Embodiment

Second Embodiment of the present invention will be described with reference to FIG. 7.

This embodiment is characterized in that the apparatus main assembly 1 includes a cover movement preventing portion for preventing movement of the protecting cover 30 itself. The shape of the protecting cover 30 is the same as that in First Embodiment. That is, the front end portion 30g for urging the cartridge side end prevents the movement of the process cartridge 10 in the direction crossing the demounting direction, and the rear end urging portion 30f for urging the cartridge rear end prevents the movement of the process cartridge 10 toward an upstream side with respect to the demounting direction.

In FIG. 7, when the protecting cover 30 is accommodated in the apparatus main assembly 1 during transportation (during product shipment), the front end-side protecting cover guide rail 34 guides the front end-side rotational movement shaft 30a of the protecting cover 30 similarly as in First Embodiment.

In First Embodiment, with respect to the demounting direction of the process cartridge 10, the protecting cover guide rail 36 is provided downstream of the protecting cover guide rail 34 and is provided with the abutting portion 36a ((A) of FIG. 5). In this embodiment, with respect to the demounting direction of the process cartridge 10, a protecting cover guide rail 38 is provided downstream of the protecting cover guide rail 34. The protecting cover guide rail 38 is provided with a recessed portion 38c. The guide shaft 30c of the protecting cover 30 enters the recessed portion 38c, so that the downward movement of the protecting cover 30 is prevented. Further, in this embodiment, the tray 46 is provided with a protecting cover urging portion 46a. At the closed position of the tray 46 in which the tray 46 covers the opening for permitting the insertion of the process cartridge 10, the protecting cover urging portion 46a prevents the upward movement of the protecting cover 30.

In this embodiment, even when the impact or the like occurs during transportation, a constitution in which the protecting cover urging portion 46a provided on the sheet feeding tray 46 urges the rear end portion of the protecting cover 30 so as not to move upward is employed. That is, in the state in which the sheet feeding tray 46 is closed, the guided shaft 30c of the protecting cover 30 is not disengaged from the recessed portion 38c of the protecting cover guide rail 38 and thus the protecting cover 30 is fixed so as not to move in the insertion and extraction direction of the process cartridge 10. As a result, compared with First Embodiment, it is possible to determine the position of the protecting cover 30 in the shipment state with higher accuracy. Thus, it becomes possible to further reduce the gap between the process cartridge 10 and the apparatus main assembly 1 in the shipment state.

Further, the sheet feeding tray 46 is generally, as shown in FIG. 8, packed with no gap by cushioning members 50 and 51 formed with expanded styrol or the like and is shipped in a state in which the image forming apparatus is packed in a packing box. However, in this embodiment, there is no need to separately pack the sheet feeding tray 46. Therefore, it is possible to eliminate waste and also to suppress an increase in production cost due to the use of a dedicated packing member.

Further, similarly as in First Embodiment, when the laser printer is not used, the protecting cover 30 is accommodated in the apparatus main assembly 1 and then the sheet feeding tray 46 can be closed. Thus, the laser printer can be kept in a downsized state.

FIG. 8 is a perspective view showing a shipment state of the image forming apparatus according to First and Second Embodiments. When the image forming apparatus (laser printer) is transported, the cushioning members 50 and 51 are provided so as to sandwich the apparatus main assembly 1. At this time, the sheet feeding tray 46 of the apparatus main assembly 1 is in the closed state and is prevented from moving by the cushioning members 50 and 51. The sheet feeding tray 46 is urged by the cushioning members 50 and 51 with no gap and therefore the sheet feeding tray 46 is not opened during transportation. Further, the sheet feeding tray 46 is not opened and therefore the protecting cover 30 which fixes the process cartridge 10 is also prevented from being pushed out by the process cartridge 10.

### Third Embodiment

This embodiment is characterized in that the protecting cover 30 fixes the process cartridge 10 and the movement of the protecting cover 30 itself is prevented by a packing member (cushioning member). Part (A) of FIG. 9 shows a state of the image forming apparatus during image formation, and (B) of FIG. 9 shows a state of the image forming apparatus during transportation (during shipment).

When the protecting cover 30 is accommodated in the apparatus main assembly 1 during product shipment, the front end-side protecting cover guide rail 34 guides the front end-side rotation shaft 30a of the protecting cover 30 similarly as in First and Second Embodiments. Further, the rear end-side protecting cover guide rail 38 is provided with the recessed portion 38c similarly as in Second Embodiment and guides the rear end-side guide shaft 30c of the protecting cover 30.

In this embodiment, the shape of the protecting cover 30 including the cartridge movement preventing portions is the same as that in First Embodiment. That is, the front end portion 30g for urging the cartridge side end prevents the movement of the process cartridge 10 in the direction crossing the demounting direction. Further, the rear end urging portion 30f for urging the cartridge rear end prevents the movement of the process cartridge 10 in the demounting direction. Further, in this embodiment, although the protecting cover 30 is not completely accommodated in the apparatus main assembly 1 as a whole (i.e., a rear portion of the protecting cover 30 is protruded from the apparatus main assembly 1 to the outside of the apparatus main assembly 1), the movement of the protecting cover 30 itself is prevented by a cushioning member 52, particularly by a protecting cover urging portion 52b. Incidentally, the cushioning member 52 is the packing member used for protecting the apparatus main assembly 1 during transportation. Similarly as in the case of the cushioning members 50 and 51 used in First Embodiment, the cushioning member 52 is provided so as to surround the apparatus main assembly 1. The movement of the protecting cover 30 is prevented by the cushioning member 52 and therefore there is no need to separately provide a member for packing the protecting cover 30.

Incidentally, in this embodiment, the sheet feeding tray 47 is of a detachably mountable type and is, as shown in (B) of FIG. 9, accommodated in a sheet feeding tray accommodating portion 52a of the cushioning member 52 formed with expanded styrol or the like in the product shipment state. Further, during image formation (during the use of the product), the user fixes the sheet feeding tray 47 at the horizontal position shown in (A) of FIG. 9 and then uses the image forming apparatus.

According to this embodiment, also in the image forming apparatus including no openable sheet feeding tray, by using the protecting cover 30, it becomes possible to fix the process cartridge 10 located at the rear portion of the apparatus main assembly 1 so as to be resistive to the impact during distribution. As a result, similarly as in First and

Second Embodiments, there is no need to use a dedicated packing member, such as expanded styrol, for fixing the process cartridge 10, so that it is possible to suppress production cost.

### Another Embodiment

In the embodiments described above, as the example of the cartridge, the process cartridge 10 which includes the image bearing member and the process means acting on the image bearing member and is detachably mountable to the apparatus main assembly 1 is explained. However, the cartridge in the present invention may also be the developing cartridge which is detachably mountable to the apparatus main assembly and includes the developing means for developing the electrostatic latent image formed on the image bearing member.

While the invention has been described with reference to the structures disclosed herein, it is not confined to the details set forth and this application is intended to cover such modifications or changes as may come within the purpose of the improvements or the scope of the following claims.

This application claims priority from Japanese Patent Applications Nos. 141623/2010 filed Jun. 22, 2010 and 109192/2011 filed May 16, 2011, which are hereby incorporated by reference.

What is claimed is:

1. An image forming apparatus for forming an image on a recording material, comprising:
a cartridge mounting portion to which a cartridge is detachably mountable;
a stacking portion for accommodating the recording material; and
a protecting cover for protecting the recording material accommodated in said stacking portion, wherein said protecting cover is movable between a first position in which the recording material accommodated in said stacking portion is protected and a second position in which movement of the cartridge mounted in said cartridge mounting portion is prevented.

2. An apparatus according to claim 1, wherein said protecting cover includes, in a state in which said protecting cover is located at the second position, a first preventing portion for preventing movement of the cartridge mounted in said cartridge mounting portion in a direction in which the cartridge is demounted from said cartridge mounting portion.

3. An apparatus according to claim 1, wherein said protecting cover includes, in a state in which said protecting cover is located at the second position, a second preventing portion for preventing movement of the cartridge mounted in said cartridge mounting portion in a direction crossing a direction in which the cartridge is demounted from said cartridge mounting portion.

4. An apparatus according to claim 1, further comprising a preventing portion for preventing movement of said protecting cover, located at the second position, from the second position.

5. An apparatus according to any one of claims 1-4, further comprising:
an opening through the cartridge is to be passed for mounting the cartridge in said cartridge mounting portion; and
an openable member movable between a closed position in which said openable member covers said opening and an open position in which said openable member opens said opening, wherein said openable member prevents movement of said protecting cover, located at the second position, from the second position.

6. An apparatus according to claim 5, wherein said protecting cover located at the first position is placed on said openable member when said openable member is located at the closed position.

7. An apparatus according to claim 1, wherein the cartridge is a process cartridge including an image bearing member and process means acting on the image bearing member.

8. An apparatus according to claim 1, wherein the cartridge is a developing cartridge including developing means for developing an electrostatic latent image formed on an image bearing member.
